(19) United States
(12) Patent Application Publication
(10) Pub. No.: US 2007/0050592 A1
(43) Pub. Date: Mar. 1, 2007

(54) Method and apparatus for accessing misaligned data streams

(76) Inventors: Michael Karl Gschwind, Chappaqua, NY (US); John David Wellman, Hopewell Junction, NY (US)

Correspondence Address: MOSER, PATTERSON & SHERIDAN LLP;IBM CORPORATION, 595 SHREWSBURY AVE, SUITE 100, SHREWSBURY, NJ, 07702, US

(21) Appl. No.: 11/216,659

(22) Filed: Aug. 31, 2005

(51) Int. Cl. G06F 12/00; G06F 13/00

(52) U.S. Cl. 711/201; 711/154

(57) ABSTRACT

One embodiment of the present method and apparatus for accessing misaligned data streams includes receiving a data request, where the data request includes a request for misaligned data, and retrieving at least a portion of the requested data from a data stream buffer associated with the data stream. If the data retrieved from the data stream buffer does not comprise all of the requested data, the remainder of the requested data is retrieved from memory and combined with the data stream buffer data. In this manner, the number of memory accesses necessary to retrieve the requested misaligned data is reduced. Additional embodiments of the present invention include mechanisms for ensuring data coherence with respect to write updates and protocol requests. Moreover, the present invention advantageously reduces the need for pipeline upset events/pipeline hazards that typically result in performance degradation in pipelined microprocessors.

### REFERENCE TO GOVERNMENT FUNDING

This invention was made with Government support under Contract No. NBCH3039004 awarded by DARPA. The Government has certain rights in this invention.

### FIELD OF THE INVENTION

The present invention relates generally to memory access in computing systems and relates more particularly to accessing misaligned data streams.

### BACKGROUND

Early processor implementations for computing systems generally required aligned data accesses (e.g., requests), i.e., wherein data to be loaded into memory was properly aligned with the base access width. Because no support was provided for data accesses that were misaligned, data returned in response to a misaligned request normally would include only a portion of the requested data, plus a portion of data that was not requested.

FIG. 1, for example, is a schematic diagram illustrating a portion of an exemplary window 100 of memory 100 in accordance with a typical early processor implementation. The window 100 comprises a plurality of individual bytes 104₀-104₅ (hereinafter collectively referred to as “bytes 104”) of data. By way of example, an access unit 102 in accordance with the window 100 comprises four bytes 104 of data. Thus, when a misaligned data request is made (for, say, four bytes 104 of data starting at byte 104₂—e.g., bytes 104₂-104₅), the requested data is not contained within a single access unit 102, but rather straddles two access units. Access units such as the access unit 102 define aligned pieces of data and may comprise words, quad words, fetch lines, transfer blocks, cache line sizes, memory pages or the like.

For the purposes of the present invention, an access unit is a unit of memory that is processed by one or more components in a memory hierarchy. In some embodiments, an access unit contains a number of bytes that is a power of two, such as one byte (a byte), two bytes (a half word), four bytes (a word), eight bytes (a double word), 16 bytes (a quad word or VMX vector word), thirty-two bytes (a sector size in at least one implementation of an industry-standard Power architecture), one of sixty-four bytes, 128 bytes, 256 bytes (cache line sizes in at least one implementation of an industry-standard Power architecture), 1024 bytes, 4096 bytes (a page, in accordance with an industry-standard Power architecture), and so forth. An access unit is said to be “naturally aligned” when stored at an address that is a multiple of the access unit size, e.g., a word is said to be naturally aligned when stored at an address that is a multiple of four bytes, a quad word is said to be naturally aligned when stored at an address that is a multiple of sixteen bytes, etc.

FIG. 2 is a schematic diagram illustrating an exemplary misaligned data item straddling two access units. A data stream comprising a plurality of bytes 204₀-204₅ (hereinafter collectively referred to as “bytes 204”) of data is contained within a window 200 of memory. Access units 202₁-202₂ (hereinafter collectively referred to as “access units 202”) comprise four bytes 204 of data, where access unit 202, comprises bytes 204₀-204₃ and access unit 202₂ comprises bytes 204₄-204₇). When a request 206 for misaligned data is received (for example, a request for “four bytes of data starting from byte 204₂”), both access units 202 are retrieved, and the data contained therein is spliced to produce the requested data 206. While effective in retrieving the requested data, such methods can be computationally tedious and slow.

Thus, there is a need in the art for a high-performance method and apparatus for accessing misaligned data streams.

### SUMMARY OF THE INVENTION

One embodiment of the present method and apparatus for accessing misaligned data streams includes receiving a data request, where the data request includes a request for misaligned data, and retrieving at least a portion of the requested data from a data stream buffer associated with the data stream. If the data retrieved from the data stream buffer does not comprise all of the requested data, the remainder of the requested data is retrieved from memory and combined with the data stream buffer data. In this manner, the number of memory accesses necessary to retrieve the requested misaligned data is reduced. Additional embodiments of the present invention include mechanisms for ensuring data coherence with respect to write updates and protocol requests. Moreover, the present invention advantageously reduces the need for pipeline upset events/pipeline hazards that typically result in performance degradation in pipelined microprocessors.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1, for example, is a schematic diagram illustrating a portion of an exemplary window of memory in accordance with a typical early processor implementation;

FIG. 2 is a schematic diagram illustrating an exemplary misaligned data item straddling two access units;

FIG. 3 is a flow diagram illustrating one embodiment of a method for responding to requests for misaligned data;

FIG. 4 is a schematic diagram illustrating one embodiment of an array of stream buffers, according to the present invention;

FIG. 5 is a schematic diagram illustrating one embodiment of a data stream buffer controller for managing data stream buffers, according to the present invention;

FIG. 6 is a schematic diagram illustrating a second embodiment of data stream buffer controller for managing data stream buffers, according to the present invention;

FIG. 7 is a schematic diagram illustrating one example of a conventional out-of-order issue processor adapted for use in conjunction with the method; and

FIG. 8 is a high level block diagram of the data retrieval method that is implemented using a general purpose computing device.

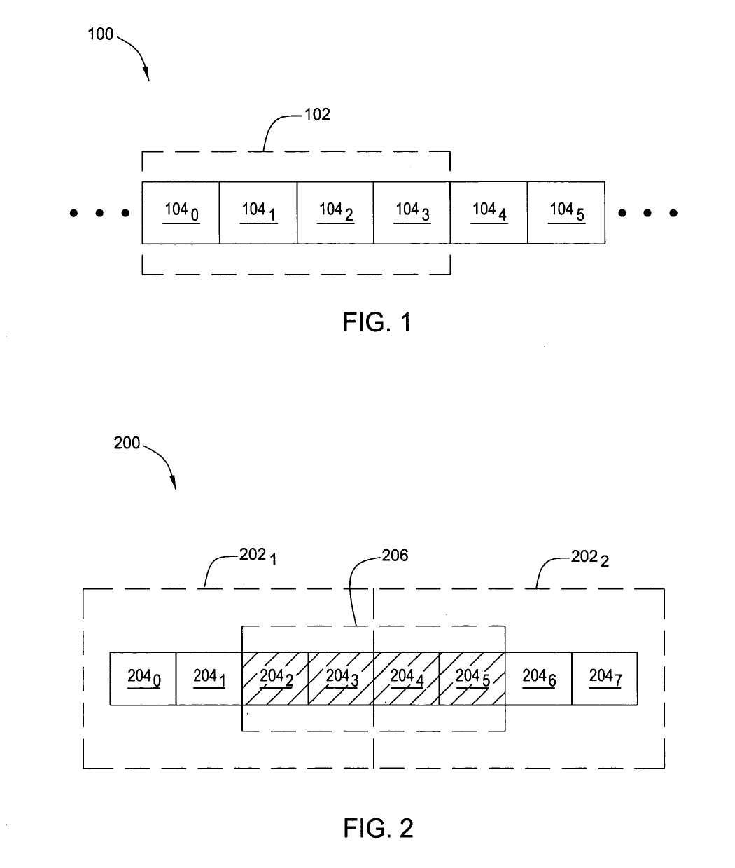

To facilitate understanding, identical reference numerals have been used, where possible, to designate identical elements that are common to the figures.

### DETAILED DESCRIPTION

In one embodiment, the present invention is a method and apparatus for accessing misaligned data streams. In one embodiment, the present invention stores at least a portion of previously accessed data in a buffer, such that when a future data misaligned data request is received, data may be retrieved from the buffer to satisfy at least a portion of the request. Thus, only a single memory access is typically required to retrieve the remaining data necessary to satisfy the misaligned data request, as opposed to the typical two memory accesses required by conventional retrieval methods.

In accordance with the present invention, data streams may be created and/or allocated by a programmer, by a compiler or other appropriately configured program, or by a runtime apparatus.

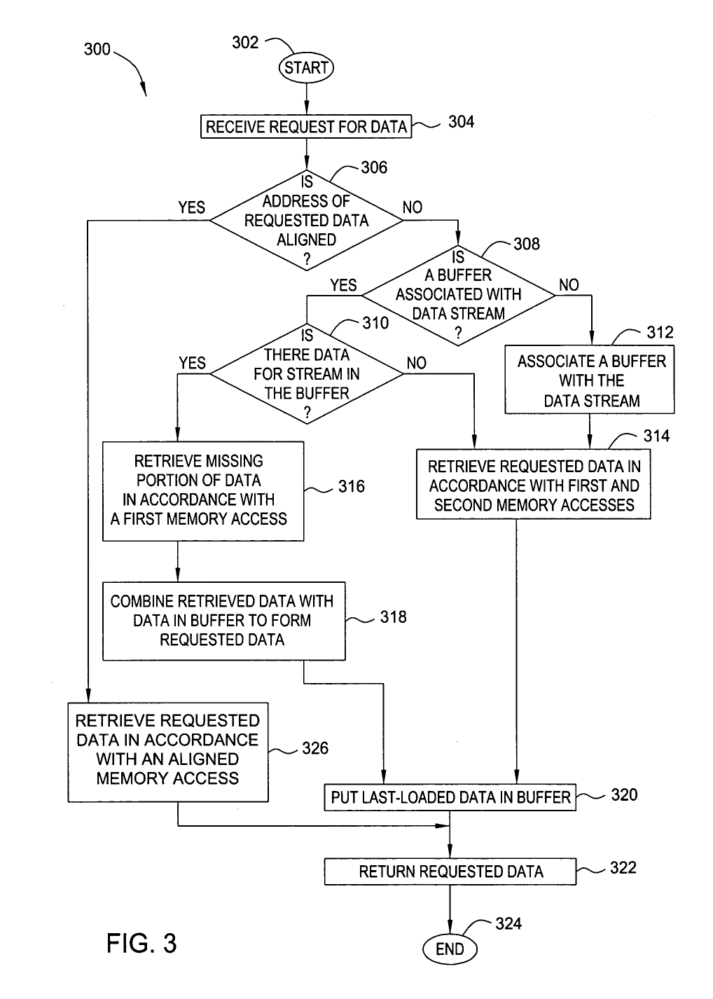

FIG. 3 is a flow diagram illustrating one embodiment of a method 300 for responding to requests for misaligned data. The method 300 may be implemented in, for example, a data access alignment unit that interacts in a computing system with a processor and a memory to fulfill processor requests for data streams in the memory, including misaligned data streams.

The method 300 starts at step 302 and proceeds to step 304, where the method 300 receives a request for data, e.g., from the processor. The data request includes an access address for the requested data (e.g., x bytes starting from byte y).

In step 306, the method 300 determines whether the address associated with the requested data is aligned. In one embodiment, this determination is made by comparing the address low-order bits of a read address to the size of the read access, as the read address is generated. If the method 300 determines that the address of the requested data is aligned, then the method 300 proceeds to step 326 and retrieves the requested data in accordance with a single aligned (“normal”) memory access. The method 300 then proceeds to step 322 and returns the requested data to the user (e.g., to the processor).

Alternatively, if the method 300 determines in step 306 that the address associated with the requested data is misaligned, the method 300 proceeds to step 308 and determines whether there is a buffer in the memory that is associated with the data stream associated with the data request (e.g., that contains at least a portion of the requested data). In one embodiment, the method 300 has access to a plurality of buffers that retain previously loaded data until the previously loaded data is replaced or invalidated. In one embodiment, each of the plurality of buffers logically contains at least: a valid bit, a data address and a cached stream context (e.g., set of data values associated with the data address). The physical layout of these elements may support a separate valid bit table, a separate valid bit and data address table (e.g., similar to a cache tag array) or various other implementations. In one embodiment, the determination as to whether buffer exists that is associated with the data stream associated with the data request is made in accordance with comparison logic embedded in a plurality of data stream buffers accessible by the method 300.

In some embodiments (e.g., where the method 300 is operatively coupled to a system memory unit), the size of the data stream buffers is limited such that each buffer stores data approximately equal in size to the largest single data transfer size supported by the memory unit. In other embodiments (e.g., where the method 300 is operatively coupled to a system data cache), the size of the data stream buffers is limited such that the buffers operate on data approximately the size of the data cache lines. In further embodiments, cache sub-blocks or segments may also be implemented.

In one embodiment, determining the association of a buffer with data stream is accomplished in any one or more of a variety of ways. For example, in one embodiment, association of buffers and data streams is accomplished in accordance with content-addressable memory or tag-based association (e.g., wherein all buffers are checked, in parallel, for at least a portion of the requested data). This enables general use of buffers for multiple data streams. In another embodiment, association of buffers and data streams is accomplished in accordance with base register number association (e.g., wherein, if general purpose register 2 is used to specify the base data address, the data stream is associated with a given buffer in a set of buffers). This enables multiple simultaneous data streams to associate with different buffers, as long as the streams use distinct base registers. In yet another embodiment, association of buffers and data streams is accomplished in accordance with specific instructions in the instruction set architecture. This enables the specification of a set of data streams to which buffers may be allocated.

If the method 300 determines that there is no such buffer, the method 300 proceeds to step 312 and associates a buffer with the data stream. In one embodiment, this is accomplished by selecting any free (empty) pre-existing buffer. In another embodiment, this is accomplished by allocating a pre-existing buffer to the data stream associated with the data request. In one embodiment, where the pre-existing buffer is not empty, this further involves evicting a data stream in the pre-existing buffer. Selection of a buffer for data stream eviction may be made in accordance with at least one of: a first-in-first-out algorithm (e.g., for selecting the pre-existing buffer that was allocated to a data stream at the earliest time), a least-recently-used algorithm (e.g., for selecting the pre-existing buffer having the least recent past accesses), a hash-based selection mechanism (e.g., based on a hash of bits for an address or data register, an instruction address or any other aspect of execution) or a random selection method.

In further embodiments, throttling of buffer allocation is performed, wherein, within a given interval (e.g. measured in some metric marking progress in execution such as clock cycles, executed instructions, executed memory instructions), only a certain number of data streams are allocated. This substantially prevents a situation in which “thrashing” occurs, e.g., in which there are more data streams than buffers such that data streams are continuously evicted from buffers. In some embodiments, logic can be implemented to detect thrashing and to select data streams for allocation to buffers, such that the number of concurrent data streams being buffered can be limited to a selected subset of associated data requests.

The method 300 then proceeds to step 314 and retrieves the requested data in accordance with a first memory access and a second memory access. That is, the method 300 retrieves data from a first memory unit (e.g., a cache line, a memory line, a fetch line, a transfer block or the like) in the first memory access, and retrieves data from a second memory unit in the second memory access. The data from the first memory unit and the data from the second memory unit each contains at least a portion of the requested data (such that the first and second memory accesses together retrieve all of the requested data), plus in some embodiments contains some amount of unrequested data. Thus, in some embodiments, retrieval of the requested data involves processing the data retrieved by the first and second memory accesses in order to produce the requested data, without any extraneous data.

Alternatively, if the method 300 determines in step 308 that a buffer in memory is already associated with the data stream associated with the data request, the method 300 proceeds to step 310 and determines whether there is any data for the data stream in the buffer (e.g., whether the buffer contains at least a portion of the requested data). In one embodiment, any buffer associated with the data stream will necessarily contain at least a portion of the requested data; however, this will not always be the case depending on the method by which buffers are associated with data streams.

In one embodiment, the buffer is accessed to determine its contents in any one or more of a number of manners, including by performing a content comparison of each data address associated with each buffer or by indexing into the buffer using architectural or microarchitectural information. In one embodiments, the buffer is indexed according to at least one of the following components: a specified base register in the load instruction, a stream identifier specified in the load instruction, a plurality of bits from the addressing mode and possible stream identifiers (e.g., implemented directly or as a hashed value index), a data address range (e.g., by selecting a plurality of buts from the effective, virtual or physical address to be used, or other forms of information derived from an instruction word, internal operation representation or address information.

If the methods 300 determines in step 310 that the buffer does not contain data for the data stream, then the method 300 proceeds to step 314 and retrieves the requested data in accordance with first and second memory accesses, as described above. Alternatively, if the method 300 determines in step 310 that the buffer does contain data for the data stream, then the method 300 proceeds to step 316 and retrieves the portions of the requested data that are missing from the buffer in accordance with a first memory access. That is, the method 300 accesses a first access unit (e.g., a cache line, a memory line, a fetch line, a transfer block or the like) in order to retrieve whatever portions of the requested data do not reside in the buffer associated with the data stream.

In step 318, the method combines the portion of the requested data that resides in the buffer with the portion of the requested data retrieved from the memory unit (e.g., in step 316) in order to produce the requested data in its complete form. In some embodiments, the combination of data in accordance with step 318 involves processing the data from the buffer and the data retrieved by the first memory access in order to produce the requested data, without any extraneous data.

In step 320, the method 300 puts the last-loaded (e.g., at least a portion of the retrieved) data in at least one buffer. In one embodiment, this buffer is the buffer associated with the data stream associated with the data request. Thus, in one embodiment, the last-loaded data complements or completes the data in the buffer. As illustrated in FIG. 3, the last-loaded data that is put in the buffer may include a single line of data (e.g., where a portion of the requested data already resided in the buffer prior to execution of the method 300) or two lines of data (e.g., where the requested data was retrieved entirely via first and second memory accesses).

In one embodiment, a single last-load buffer is associated with a data stream. In alternative embodiments, a plurality of last-load buffers are provided, where each last-load buffer may be associated with a specific base register use (e.g., such that only the buffer associated with a specific base register is considered for sourcing the data stream). In further embodiments, any single last-load buffer may be associated with a plurality of base registers. In still further embodiments, each base register is associated either with a single corresponding base register or with a plurality of last-load buffers. In further embodiments still, a plurality of last-load buffers may be accessed associatively to determine if one of the plurality of last-load buffers contains the appropriate last-load data.

In step 322, the method 300 returns the requested data (e.g., to the processor or requester). The method 300 then terminates in step 324.

In this manner, the method 300 reduces the number of memory accesses necessary to retrieve requested data that is misaligned. When at least a portion of the requested data can be retrieved from a buffer, only one memory access is typically necessary to fulfill the rest of the request (e.g., by retrieving the portions of the data not contained in the buffer). The requester (e.g., processor) need provide no other information in addition to a single data address per misaligned data request, thus substantially transparent access to misaligned data is provided. This is in contrast to conventional methods for accessing misaligned data, which normally require at least two memory accesses and subsequent splicing as discussed above. This significantly reduces the amount of time generally required to retrieve misaligned data. Moreover, once the requested data has been fully retrieved, it is stored in the associated buffer so that the data may be used for satisfying subsequent data requests in a time-efficient manner.

In one embodiment of the present invention, aligned data requests can also optionally be satisfied from stream buffers. In another embodiment of the present invention, a data stream is initiated by an instruction or instruction sequence embedded in the method 300.

In yet another embodiment of the present invention, a reference stream being serviced by a data stream buffer includes requests that correspond either to non-overlapping memory access or non-adjacent memory accesses.

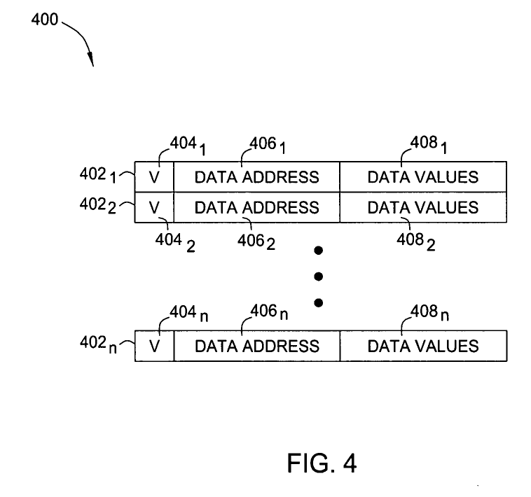

FIG. 4 is a schematic diagram illustrating one embodiment of an array 400 of stream buffers 402₁-402ₙ (hereinafter collectively referred to as “stream buffers 402”), according to the present invention. In accordance with the present invention, a stream unit implementing the method 300 will have access to a plurality of stream buffer 402. In one embodiment, each stream buffer 402 contains at least: a valid bit 404₁-404ₙ (hereinafter collectively referred to as “valid bits 404”), at least a portion of a data address 406₁-406ₙ (hereinafter collectively referred to as “data addresses 406) and data values 408₁-408ₙ (hereinafter collectively referred to as “data values 408”) or cached stream context associated with the data address 406.

In the embodiment illustrated in FIG. 4, the valid bit 404, data address 406 and associated data values 408 for each stream buffer 402 are stored within a single storage location (e.g., array 400). However, in an alternative embodiment, the valid bits 404 may be stored separately from the data addresses 406 and data values 408, e.g., within a separate valid tags table. In yet another embodiment, both the valid bits 404 and the data addresses 406 may be stored separately from the data values 408, e.g., in a separate tags table, similar to a cache tag array. In all configurations, however, the stream buffers 402 will contain the same minimum components: the valid bit 404, the data address 406 and the associated data values 408.

In one embodiment, the data values 408 are the size of an access unit. In further embodiments, the data values correspond to naturally aligned access units (e.g., naturally aligned with respect to the access unit size). In further embodiment still, the data addresses 406 refer to addresses of the aligned access units. In yet another embodiment, the low-order bits corresponding to low-order address bits (which must be zero to indicate natural alignment, in accordance with an access unit size) are not stored. In another embodiment, the low-order bits are not included in an address match operation.

The plurality of stream buffers 402 may be accessed in any one of a plurality of manners, including content comparison (e.g., of each data address 406) or indexing (e.g., using either architectural or microarchitectural information). Indexing may be performed in accordance with one or more of a plurality of components, including: a specified base register in a load instruction, a stream identifier specified in a load instruction, a plurality of bits from an addressing mode and/or possible stream identifiers (e.g., either directly or as hashed index values), an address range (e.g., by selecting a plurality of bits from the effective, virtual or physical address to be used) or other forms of information derived from an instruction word, internal operation representation or data address.

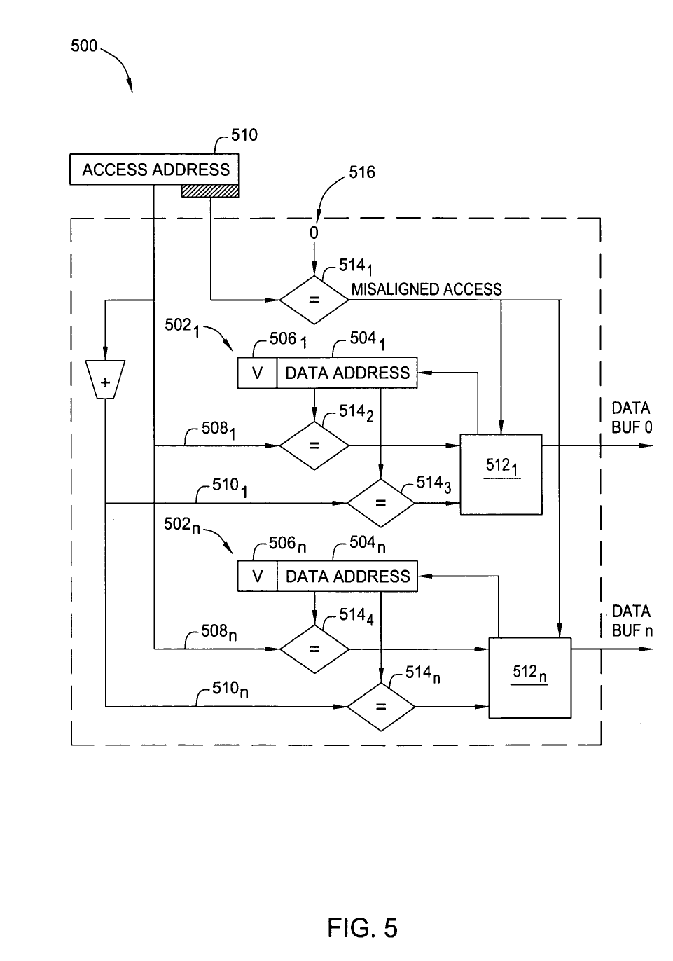

FIG. 5 is a schematic diagram illustrating one embodiment of a data stream buffer controller 500 for managing data stream buffers 502₁-502ₙ (hereinafter collectively referred to as “stream buffers 502”), according to the present invention. As discussed above, each stream buffer 502 minimally contains: at least a portion of a data address 504₁-504ₙ (hereinafter collectively referred to as “data addresses 504”) and a valid bit 506₁-506ₙ (hereinafter collectively referred to as “valid bits 506”).

There is also shown in FIG. 5 an address matching logic 514₁-514ₙ (hereinafter collectively referred to as “address matching logic 514”) for matching the address of either the high access unit or the low access unit that is straddled by a misaligned data request. In addition, control logic 512₁-512ₙ (hereinafter collectively referred to as “control logic 512”) are also illustrated. In one embodiment, the control logic 512 is controlled by misalignment detection logic 516 that compares at least one low-order bit for correct alignment (e.g., by testing that the low-order bit is equal to zero).

In some embodiments, data streams contained in the stream buffers 500 stride through memory in either address incrementing or address decrementing order. Thus, in order to locate the appropriate stream buffer 500 from which to retrieve a portion of an access address (e.g., a requested data item, for example as requested in step 304 of the method 300), it is typically necessary to detect if a data stream in a stream buffer 500 matches either the high portion or the low portion of an access address spanning a line (or other such memory boundary). This can be accomplished by performing two comparisons for each data stream in the stream buffers 500: a first comparison 508₁-508ₙ with a non-incremented high address portion, and then a second comparison 510₁-510ₙ with an incremented high address portion.

In one embodiment, the valid bits 506 stored in the stream buffers 502 are examined in order to determine whether the access address 510 is misaligned (e.g., straddles two or more data addresses 504). Thus, when the access address 510 is misaligned, the access address 510 will match at least a portion of one or more of the data addresses 504. Information for those data addresses 504 that at least partially match the access address 510 are forwarded to respective control logic 512₁-512ₙ. When a match to at least a portion of a data address 504 is detected, the control logic 512 selects the corresponding data stream. In some embodiments, the control logic 512 may further include data merge logic for combining portions of retrieved access units (e.g., in accordance with step 318 of the method 300).

In one embodiment, the stream buffers 500 support only address-incrementing data streams.

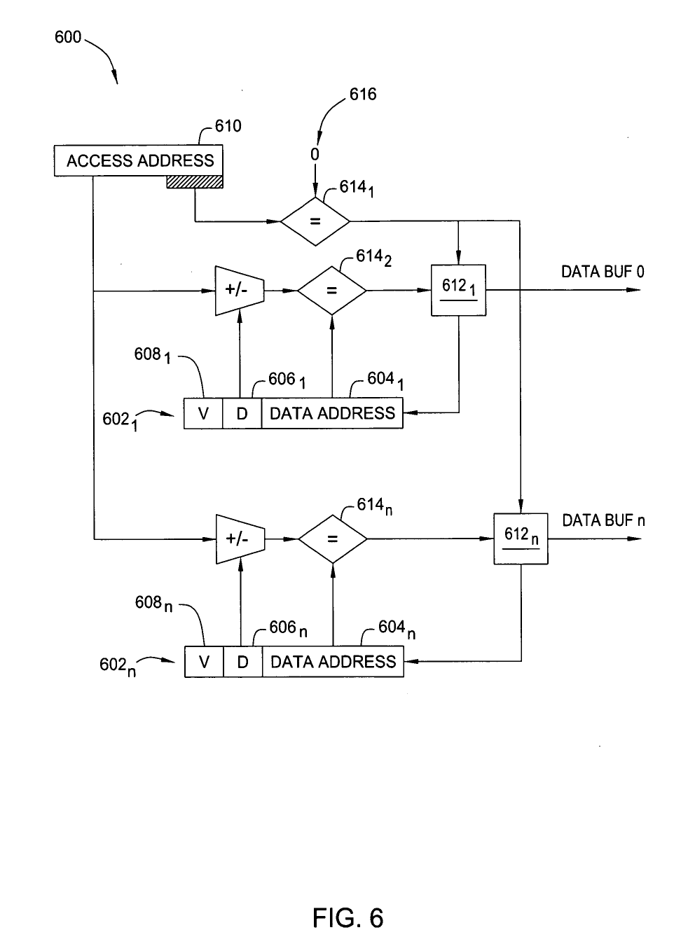

FIG. 6 is a schematic diagram illustrating a second embodiment of data stream buffer controller 600 for managing data stream buffers 602₁-602ₙ (hereinafter collectively referred to as “stream buffers 602”), according to the present invention. Each stream buffer 602 comprises at least a data address 604₁-604ₙ (hereinafter collectively referred to as “data addresses 604”), a direction bit 606₁-606ₙ (hereinafter collectively referred to as “direction bits 606”) and a valid bit 608₁-608ₙ (hereinafter collectively referred to as “valid bits 608”).

There is also shown in FIG. 6 an address matching logic 614₁-614ₙ (hereinafter collectively referred to as “address matching logic 614”) for matching, under the control of the direction bits 606, the address of either the high access unit or the low access unit that is straddled by a misaligned data request. In addition, control logic 612₁-612ₙ (hereinafter collectively referred to as “control logic 612”) is also illustrated.

As discussed above, in order to locate the appropriate stream buffer from which to retrieve a portion of an access address (e.g., a requested data item, for example as requested in step 304 of the method 300), it is typically necessary to detect if a data stream in a stream buffer 602 matches either the high portion or the low portion of an access address spanning a line (or other such memory boundary).

This is accomplished in FIG. 6 by testing against either the line address portion (e.g., a number of most significant bits in accordance with the line memory unit size) of the incremented or decremented access address 610 under the control of the direction bits 606. In some embodiments, two comparisons must be performed for each single stream buffer 602: a first comparison with a non-incremented (or non-decremented, under the control of the direction bit) most-significant address portion of the access address 610 and a second comparison with an incremented (or non-decremented, under the control of the direction bit 606) most-significant address portion of the access address 610. In other embodiments, three match conditions are tested to allow for a match on the incremented, decremented or original address portion.

In one embodiment, the data stream buffer controller 600 further includes misalignment testing logic 616 for suppressing access to data stream buffers when an aligned memory access is issued. In one embodiment, the misalignment testing logic 616 compares at least one low-order bit for equality to zero.

For the stream buffers 600 illustrated in FIG. 6, a stream direction for a data stream is identified in accordance its respective direction bit 606, which functions as a stream direction identifier. In one embodiment, alternative directional data-buffer addresses can also be used to eliminate the need for address incrementor or decrementor logic. When the data stream address is incrementing, an unmodified most-significant address portion of the data address can be stored, and when an address decrementing data stream is stored, a decremented most-significant address portion of the data address is stored. In this case, the data address 604 can be directly compared to the most significant portion of the access address 610, and, in the case of a match, the necessary data could be provided from the corresponding buffer 602.

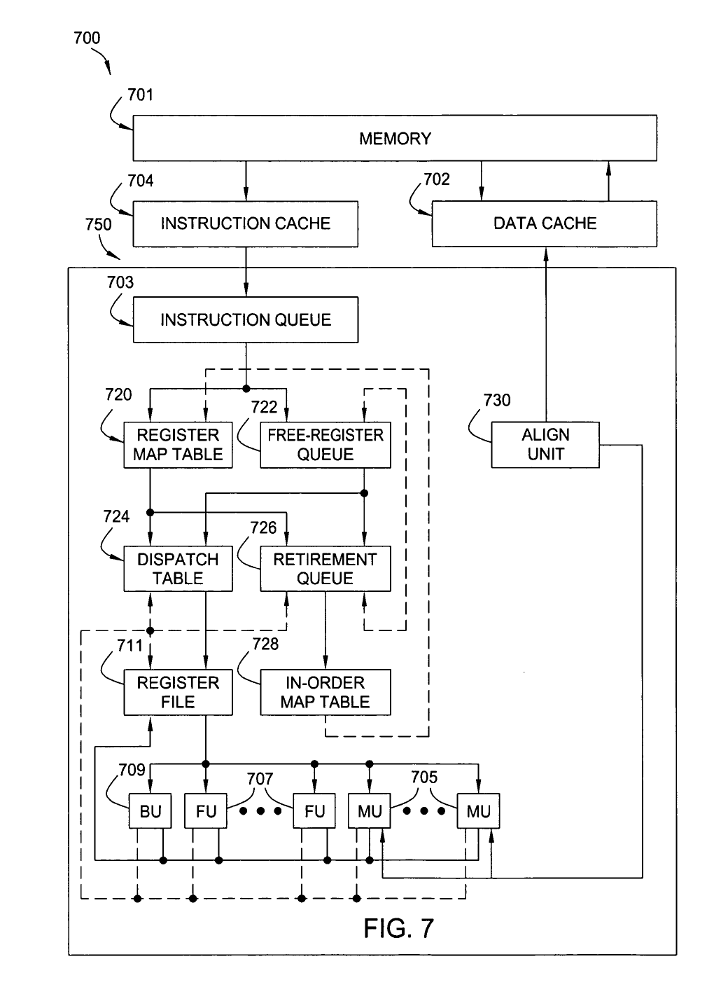

FIG. 7 is a schematic diagram illustrating one example of a conventional out-of-order issue processor 700 adapted for use in conjunction with the method 300. One embodiment of such a processor that may be adapted to benefit from the present invention is described by M. Moudgill et al. in “Register Renaming and Dynamic Speculation: An Alternative Approach”, Proceedings of the 26^{th} Annual International Symposium On Microarchitecture, pp. 202-213, December 1993. The processor 700, similar to typical out-of-order issue processors, comprises: (1) a mechanism for issuing instructions out-of-order (including the ability to detect dependencies among instructions, rename registers used by an instruction and detect the availability of resources used by an instruction); (2) a mechanism for maintaining the out-of-order state of the processor 700 (which reflects the effects of instructions as they are executed); (3) a mechanism for retiring instructions in program order, simultaneously updating the in-order state with the effects of the instruction being retired (e.g., for retiring instructions when the effects of the instruction being retired are correct); and (4) a mechanism for retiring an instruction in program order without updating the in-order state (effectively canceling the effects of the instruction being retired) and for resuming in-order execution of a program starting at the instruction being retired (which implies canceling all of the effects present in the out-of-order state) (e.g., for retiring instructions under abnormal conditions resulting from the effects of the instruction being retired or some external event)

Specifically, the processor 700 comprises at least a memory subsystem 701, a data cache 702, an instruction cache 704 and a processor unit 750. The processor unit 750 further comprises an instruction queue 703, a plurality of memory units 705 that perform load and store operations, a plurality of functional units 707 that perform integer, logic and floating point operations, a branch unit 709, a register file 711, a register map table 720, a free-registers queue 722, a dispatch table 724, a retirement queue 726 and an in-order map table 728.

According to this configuration, instructions are fetched from the instruction cache 704 or the memory subsystem 701 under the control of the branch unit 709. The fetched instructions are placed in the instruction queue 703 for future extraction. The architected register names used by the instructions for specifying the operands are renamed according to the contents of the register map table 720, which specifies the current mapping from architected register names to physical registers. The architected register names used by the instructions for specifying the destinations for the results are assigned physical registers extracted from the free-register queue 707, which contains the names of physical registers not currently being used by the processor 700. The register map table is updated with the assignments of physical registers to the architected destination register names specified by the instructions.

Instructions with all their registers renamed are placed in the dispatch table 724; instructions are also placed in the retirement queue 726, in program order, including their addresses, their physical and their architected register names. Instructions are dispatched from the dispatch table 724 when all of the resources required by the instructions are available (e.g., physical registers have been assigned the expected operands, and functional units are free). The operands used by the instructions are read from the register file 711, which typically includes general purpose registers, floating point registers, and condition registers. Instructions are executed, potentially out-of-order, in a corresponding memory unit 705, functional unit 707 or branch unit 709.

Upon completion of execution, the results from the instructions are placed in the register file 711. Instructions in the dispatch table 724, which wait for the physical registers set by the instructions completing execution, are notified. The retirement queue 726 is notified of the instructions completing execution, including whether any of the instructions have raised exceptions. Completed instructions are then removed from the retirement queue 726 in program order (e.g., from the head of the queue back). At retirement time, if no exceptions have been raised by an instruction, the in-order map table 728 is updated so that the architected register names point to the physical registers in the register file 711, which contain the results from the instructions being retired. The previous register names in from the in-order map table 728 are returned to the free-registers queue 722.

Alternatively, if a completed instruction has raised an exception, program control is set to the address of the instruction being retired from the retirement queue 726. The retirement queue 726 is then cleared, thereby canceling all unretired instructions, and the register map table 720 is set to the contents of the in-order map table 728. Any register not in the in-order map table 728 is added to the free-registers queue 722.

In accordance with the present invention, the processor 700 is augmented such that is further comprises an align unit 730. The align unit 730 further comprises a data stream buffer controller (not shown) such as those illustrated in FIGS. 5 or 6 and is operatively coupled with a method for retrieving misaligned data such as the method 300. The align unit 730 is interconnected with the processor unit 750 and memory subsystem 701. In this embodiment, the processor 700 is further enabled to identify memory instructions to be processed in accordance with the present invention. For example, in one embodiment, the processor 700 would be configured to process all instruction in accordance with a data stream buffer in the align unit. In another embodiment, only some memory instructions e.g., vector load instructions) are processed in accordance with the present invention.

The align unit 730 and associated functionalities are implemented in conjunction with conventional out-of-order processing functionalities as follows. A load instruction is issued to the memory units 705 and is identified as being subject to processing by the align unit 730. In one embodiment, all memory operations are processed by the align unit 730. In further embodiments, instructions must be decoded before it can be determined whether they are subject to processing by the align unit 730.

If an instruction is not subject to processing by the align unit 730, the memory subsystem 701 is accessed directly, and misalignment conditions are treated in accordance with conventional methods. In one embodiment, an instruction is subject to processing by the align unit 730 only if the associated data corresponds to certain data types or data type sizes (e.g., vector instructions). In another embodiment, special instruction forms indicate whether an instruction should be subject to processing by the align unit 730. In yet another embodiment, a determination as to whether an instruction is subject to processing by the align unit 730 is made in accordance with a predictor. In one embodiment, the predictor assists in predicting whether a load operation is part of a stream of misaligned data requests/memory accesses.

However, if the instruction is subject to processing by the align unit 730, then the memory address and other information necessary for specific implementation of the align unit 730 in accordance with the present invention (e.g., a register specifier to identify a data stream, a stream identifier or the like) is forwarded to the align unit 730.

In accordance with the present invention, in one embodiment, only a single memory port used by the memory unit(s) 705 (e.g., to access the data cache 702 or external memory 701) is allocated for a single access by the align unit 730. If the align unit 730 determines that two memory accesses are required to be executed, two memory port accesses must be scheduled. This will require implementation of at least one interface mechanism, such as a test that determines whether the memory port is available in a successive cycle, or whether another memory operation is scheduled to access the memory port in that cycle.

If it is determined that another memory operation is scheduled to access the memory port in that cycle, another cycle is allocated in the schedule by performing a synchronization method (e.g., to synchronize the two memory operations). In one embodiment (e.g., in accordance with a global stall), synchronization involves inserting at least one stall cycle (e.g., where operations that are dependent on a load to be stalled are likewise stalled), so that the present misaligned memory operation may access two memory units. In another (e.g., stall-free) embodiment, synchronization involves performing a flush cycle and terminating at least one instruction succeeding the present instruction, causing the present instruction to be re-executed. For example, one suitable stall-free synchronization method that may be implemented in accordance with the present invention is described in greater detail in U.S. Pat. No. 6,192,466, which is herein incorporated by reference in its entirety. In further embodiments, other synchronization methods may be implemented in order to synchronize the present instruction's resource requirements (which are typically increased when a misaligned data request requires the retrieval of two memory units) with other instructions being executed by the processor 700.

In one embodiment, an apparatus for accessing misaligned data streams in accordance with the present invention is implemented in conjunction with an improved memory protection subsystem, where the memory protection subsystem is adapted to identify whether a misaligned data item will cross a page boundary. In such a case, the memory protection subsystem may take action to ensure the enforcement of appropriate memory accesses.

In one embodiment, such enforcement involves trapping the operating system for resolution of the page boundary crossing by system software. In another embodiment, such enforcement involves trapping to microcode to perform protection checks (e.g., to ensure that both a first page and a second page indicated by a misaligned data request crossing a page boundary is permitted) and raising an exception if at least one of the misaligned data requests is not allowed. In another embodiment, such enforcement involves performing two translation look-aside buffer (TLB) accesses (in parallel or in series) and raising an exception if at least one of the misaligned data requests is not allowed.

Data stream buffers in accordance with the present invention may store address tags in any one or more of a variety of formats, including the use of virtual addresses (wherein special care must typically be taken to ensure correct processing of aliases, remote intervention requests and the like). In another embodiment, data stream buffers in accordance with the present invention store address tags using physical addresses. In one embodiment of such an implementation, the memory translation subsystem returns two addresses: a first address to be used in accessing the last-load buffer (or a first memory access, when two memory accesses are required), and a second address to be used for a single memory access (or a second memory access, when two memory accesses are required). In yet another, less complex, embodiment of this implementation, retrievals of data that cross page boundaries are always performed in accordance with two memory accesses. In yet another embodiment, data stream buffers in accordance with the present invention store address tags using virtual index bits (used to identify data stream buffers) in conjunction with physical tags.

In another embodiment of the present invention, logic is incorporated for detecting when the access sequence of a data request is in address ascending or address descending order. In at least one of these cases, at least one bit of information is stored to indicate the direction of the access stream.

In another embodiment of the present invention, data stream buffers are used only for lines that are read-only in the instruction cache according to a cache protocol (e.g., shared state). In yet another embodiment, the data stream buffers fully participate in multiprocessor coherence protocols.

In another embodiment, writes to data addresses maintained in a data stream buffer invalidate the buffer. In an alternative embodiment, data stream buffers are updated when a write is detected that would write to a memory address maintained (partially or completely) within any of the data stream buffers.

In another embodiment, address comparison logic (e.g., 512 of FIG. 5 and 612 of FIG. 6) is used to determine if a data stream buffer is to be invalidated or write-updated in response to a write request. This maintains the consistency of the data in the data stream buffer with respect to write updates. In a further embodiment, the decision to update is made in accordance with only one comparison for equality (e.g., only paths 508 are used in accordance with FIG. 5). In a power-optimized embodiment, at least one path is de-energized (e.g., by clock gating or power gating).

In another embodiment, the present invention is implemented within a multiprocessor system. In one instance of this embodiment, cache coherence is maintained by routing all coherence protocol requests to the align unit (e.g., 730 of FIG. 7), which checks for matches and takes appropriate action to preserve cache coherence. In another instance of this embodiment, cache coherence is maintained by evicting data streams from the data stream buffers when associated addresses are referenced in protocol requests (e.g., coherence requests), wherein a remote processor obtains access that is exclusive and/or write. In another embodiment, cache coherence is maintained by including a data stream buffer's associated data stream buffer controller in the coherence traffic.

In another embodiment, at least a portion of the address comparison logic implemented in a data stream buffer controller (e.g., 512 of FIG. 5 and 612 of FIG. 6) is shared with at least a portion of a second matching logic implemented for providing data coherence with respect to at least one of: a write request from a local microprocessor core or a protocol request from a remote microprocessor core.

In another embodiment, address comparison logic (e.g., 512 of FIG. 5 and 612 of FIG. 6) is used to determine if a data stream buffer is to be invalidated in response to a protocol request. In a further embodiment, the decision to update is made in accordance with only one comparison for equality (e.g., paths 508 are used only in accordance with FIG. 5). In a power-optimized embodiment, at least one path is de-energized (e.g., by clock gating or power gating).

In another (simplified) embodiment, a set of coherence protocol requests would trigger the invalidation of all data stream buffers.

In another embodiment, a first level of cache contains information indicating that at least a portion of a particular cache line is being maintained (or is likely or possibly being maintained) in a data stream buffer. In another embodiment, such information is maintained in another level (e.g., second, third, etc.) of cache. In a further embodiment, such information assists in implementing multiprocessor coherence protocols. In yet another embodiment, such information is used to synchronize writes to memory with read-access using the last-load buffers in the data stream buffers.

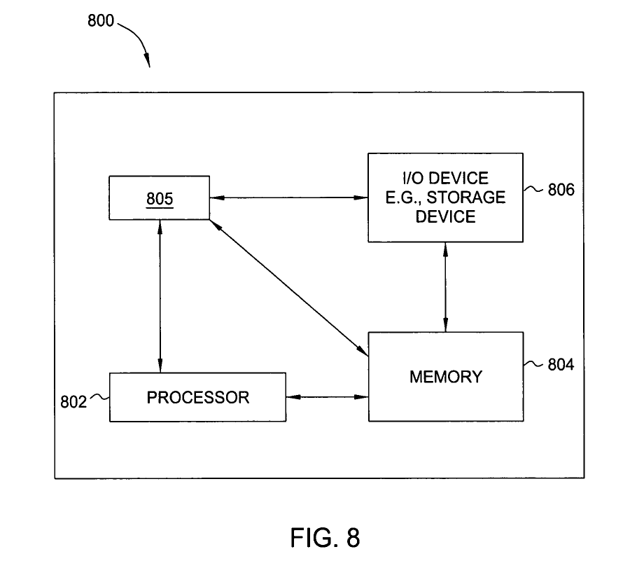

FIG. 8 is a high level block diagram of the data retrieval method that is implemented using a general purpose computing device 800. In one embodiment, a general purpose computing device 800 comprises a processor 802, a memory 804, a data retrieval module 805 and various input/output (I/O) devices 806 such as a display, a keyboard, a mouse, a modem, and the like. In one embodiment, at least one I/O device is a storage device (e.g., a disk drive, an optical disk drive, a floppy disk drive). It should be understood that the data retrieval module 805 can be implemented as a physical device or subsystem that is coupled to a processor through a communication channel.

Alternatively, the data retrieval module 805 can be represented by one or more software applications (or even a combination of software and hardware, e.g., using Application Specific Integrated Circuits (ASIC)), where the software is loaded from a storage medium (e.g., I/O devices 806) and operated by the processor 802 in the memory 804 of the general purpose computing device 800. Thus, in one embodiment, the data retrieval module 805 for retrieving stored data (including misaligned data) described herein with reference to the preceding Figures can be stored on a computer readable medium or carrier (e.g., RAM, magnetic or optical drive or diskette, and the like).

Thus, the present invention represents a significant advancement in the field of memory access. A method and apparatus are provided that enable misaligned data requests to be satisfied in accordance with only a single memory access, as opposed to the typical two accesses required by conventional data retrieval methods, by storing at least a portion of previously accessed data in a buffer. Thus, when a future data request is received, data may be retrieved from the buffer to satisfy at least a portion of the request, where the other portion of the requested data is provided via a single memory access.

While the foregoing is directed to the preferred embodiment of the present invention, other and further embodiments of the invention may be devised without departing from the basic scope thereof, and the scope thereof is determined by the claims that follow.

1. A method for retrieving misaligned data from a data stream, said method comprising:
receiving a data request, said data request requesting said misaligned data;
retrieving at least a portion of said misaligned data from a data stream buffer associated with said data stream;
retrieving a remaining portion of said misaligned data from a memory unit in accordance with a first memory access; and
combining said at least a portion of said misaligned data and said remaining portion of said misaligned data to produce said requested misaligned data, said combining being performed under the control of address comparison logic provided by a data stream buffer controller.

2. The method of claim 1, wherein said data stream buffer contains an access unit that is naturally aligned with respect to a size of said access unit.

3. The method of claim 2, wherein said address comparison logic is obtained by comparing an unmodified data address to at least one of: an incremented data address or a decremented data address.

4. The method of claim 1, wherein consistency of data maintained in said data stream buffer is maintained with respect to at least one write update by at least one of: invalidating said data stream buffer in response to said at least one write update or write-updating said data stream buffer in response to said at least one write update.

5. The method of claim 1, wherein a reference data stream being serviced by said data stream buffer comprises at least one data request that corresponds to at least one of: a non-overlapping data memory access and a non-adjacent data memory access.

6. The method of claim 1, wherein at least one cache line in at least one cache hierarchy level indicates at least one of: a presence of at least a portion of said at least one cache line in said data stream buffer or a likelihood of a presence of at least a portion of said at least one cache line in said data stream buffer.

7. The method of claim 1, wherein at least one data stream in said data stream buffer is evicted in response to at least one coherence request.

8. The method of claim1, wherein said data stream buffer controller is included in coherence traffic.

9. The method of claim 1, wherein said data stream buffer is selected from among a plurality of data stream buffers in accordance with at least one of: content-addressable memory association, tag-based association, base register number association or a specific instruction from an instruction set architecture.

10. The method of claim 1, wherein said buffer is indexed according to at least one of: a specified base register in a load instruction, a data stream identifier specified in a load instruction, a plurality of bits from an addressing mode, a plurality of bits from data stream identifiers or a data address range.

11. A computer readable medium containing an executable program for retrieving misaligned data from a data stream, where the program performs the steps of:
receiving a data request, said data request requesting said misaligned data;
retrieving at least a portion of said misaligned data from a data stream buffer associated with said data stream, said data stream buffer storing an access unit that is naturally aligned with respect to a size of said access unit;
retrieving a remaining portion of said misaligned data from a memory unit in accordance with a first memory access; and
combining said at least a portion of said misaligned data and said remaining portion of said misaligned data to produce said requested misaligned data.

12. The computer readable medium of claim 11, wherein said data stream buffer is indexed in accordance with at least one of: a specified base register in a load instruction, a data stream identifier specified in a load instruction, a plurality of bits from an addressing mode, a plurality of bits from data stream identifiers or a data address range.

13. The computer readable medium of claim 11, further comprising:
receiving a coherence request; and
evicting at least one data stream in said data stream buffer in response to said coherence request.

14. Apparatus for retrieving misaligned data from a data stream, said apparatus comprising:
means for receiving a data request, said data request requesting said misaligned data;
means for retrieving at least a portion of said misaligned data from a data stream buffer associated with said data stream;
means for retrieving a remaining portion of said misaligned data from a memory unit in accordance with a first memory access; and
means for combining said at least a portion of said misaligned data and said remaining portion of said misaligned data to produce said requested misaligned data, said combining being performed under the control of address comparison logic provided by a data stream buffer controller.

15. The apparatus of claim 14, wherein said data stream buffer contains an access unit that is naturally aligned with respect to a size of said access unit.

16. The apparatus of claim 14, wherein a reference data stream being serviced by said data stream buffer comprises at least one data request that corresponds to at least one of: a non-overlapping data memory access and a non-adjacent data memory access.

17. The apparatus of claim 14, wherein consistency of data maintained in said data stream buffer is maintained with respect to at least one write update by at least one of: invalidating said data stream buffer in response to said at least one write update or write-updating said data stream buffer in response to said at least one write update.

18. The apparatus of claim 14, wherein at least one data stream in said data stream buffer is evicted in response to at least one coherence request.

19. The apparatus of claim 14, wherein at least a portion of said address comparison logic is shared with at least a portion of a second matching logic implemented for providing data coherence with respect to at least one of: a write request from a local microprocessor core or a protocol request from a remote microprocessor core.

20. The apparatus of claim 14, wherein said data stream buffer is selected from among a plurality of data stream buffers in accordance with at least one of: content-addressable memory association, tag-based association, base register number association or a specific instruction from an instruction set architecture.
